(19) United States
(12) Patent Application Publication
(10) Pub. No.: US 2017/0157862 A1
(43) Pub. Date: Jun. 8, 2017

(54) METHOD FOR PRODUCING THREE-DIMENSIONAL OBJECTS BY RAPID PROTOTYPING WITH INCREASED EFFICIENCY

(71) Applicant: HERAEUS KULZER GMBH, Hanau (DE)

(72) Inventor: Christian BAUER, Schöllkrippen (DE)

(73) Assignee: HERAEUS KULZER GMBH, Hanau (DE)

(21) Appl. No.: 15/319,975

(22) PCT Filed: Jun. 17, 2015
(86) PCT No.: PCT/EP2015/063561

§ 371 Date: Dec. 19, 2016

(30) Foreign Application Priority Data
Jun. 18, 2014 (DE) 10 2014 108 633.3

(51) Int. Cl. B29C 67/00

(52) U.S. Cl. CPC B29C 67/0096; B29C 67/007; B29C 67/0092; B33Y 30/00

(57) ABSTRACT

The invention relates to a device and a method for the production of three-dimensional objects, in particular of at least parts of dental prosthetic restorations, by a stripping device wiping off plastic material, which protrudes vertically beyond a container, into a collecting container and forms a projection surface. In particular, a stripping device and a light source are simultaneously guided, at a defined distance, across the liquid light-curing plastic material, whereby the stripping device is guided at a defined distance right ahead of the light source and forms the projection surface for the illuminated field of the light source.

The invention relates to a device and a method for the production of three-dimensional objects, in particular of at least parts of dental prosthetic restorations, by a stripping device wiping off plastic material, which protrudes vertically beyond a container, into a collecting container and forms a projection surface. In particular, a stripping device and a light source are simultaneously guided, at a defined distance, across the liquid light-curing plastic material, whereby the stripping device is guided at a defined distance right ahead of the light source and/or the illuminated field and forms the projection surface for the illuminated field of the light source. The invention also relates to a method for producing a homogenised distribution of light intensity with a spatial light modulator and to a rapid prototyping method using a method of this type.

A level regulation of the resin container during the construction process is known from the prior art. Accordingly, the level regulation is controlled, for example, by a sensor for surface scanning and a control for adaptation of the pre-set height of the trough (level of the resin). The height of the filling level of the resin is controlled for each layer and, if applicable, regulated to a pre-set level. Subsequently, the construction process is continued.

There are also methods, in which no regulation of the filling height for the process is required. Said methods illuminate the resin-filled trough from below through a transparent layer. The component is drawn upwards layer-by-layer. The height of the filling level serves only for implementation of a construction process and is not corrected during the construction phase. A method of this type is known from EP 2337668 B1.

Moreover, there is some technology in which the resin floats on a layer of salt water. Said method therefore utilises very little resin and thus saves material and dispenses with a mechanical axis. This is known, for example, of the Peachy Printer.

A device is known from WO 95/31325, in which the container comprises an overflow for setting the level of the curable resin. The overflow can be designed to be V-shaped. A device, which may comprise a smoothing member and is situated above the surface, is used for application of a layer. Said device applies a new homogeneous layer of the curable resin. This method is disadvantageous due to the laborious dosing and triggering of the device for uniform application of the layer to be polymerised.

DE4414775 A1 discloses a device for the production of three-dimensional objects having a wiper and an inlet and outlet provided in the container via which material is transported from the bath to the surface when the carrier is being lowered. The container is provided with an outlet whose upper edge is situated lower than the upper edge of the container. The device is disadvantageous in that a further positioning device needs to be lowered by the thickness of the layer in order to adjust the layer thickness above the carrier (column 3, lines 4 to 40). The material is conveyed exactly in front of the wiper, which distributes it subsequently. Another disadvantage results from the fact that the wiper first needs to distribute the material across the carrier.

Another focus of rapid prototyping methods is on the light sources. Accordingly, rapid prototyping methods involve the use of ultraviolet (UV) lasers and, increasingly, of UV-LED data projectors. Methods for this purpose are known, for example, from EP 1 880 830 A1 and EP 1 894 705 A2. Lasers are disadvantageous due to their illuminated field being punctiform. The UV light of the light source is projected onto a light-curing plastic material as the illuminated field. The projection involves the use of an optical system and a spatial light modulator. Due to the optical system, the distribution of light and/or the intensity distribution is inhomogeneous. The peripheral regions of the illuminated field typically show lower intensity than the regions in the centre of the illuminated field. Due to this effect, also called barrel image, the light-curing plastic material does not receive the same intensity in all places, which causes it to cure differently and therefore not homogeneously.

EP 1 982 824 A2 proposes to homogenise the intensity distribution by reducing the brighter pixels of the UV data projector to the intensity level of the pixels on the periphery by means of a grey distribution.

This is disadvantageous in that the grey distribution can be attained only through accurate control of the intensity. It is therefore also an object of the invention to provide a simpler method that can be used to attain a similar effect.

It was the object of the invention to be able to provide a constant level with respect to the z-axis of polymerisable material, such as a composition comprising monomers, with little design effort and without any need for further positioning units or measuring facilities. Moreover, the object was to enable a constant filling height regulation. Moreover, a device was to be developed that allows for a more rapid construction process of the three-dimensional objects. In particular, a less laborious method is to be provided, in which the procedural steps can be performed more rapidly and, in particular, in which a satisfactory homogenisation of the light intensity of the illuminated field is attained. The method shall be implementable as inexpensively as possible.

The objects of the invention are solved by a device according to claim 1 and by a method according to claim 7, in which the light-curing plastic material at the upper edge of the walls of the container is removed in planar direction along the projection surface by means of a stripping device. In this context, the plastic material preferably is a light-curing plastic material, such as a composition comprising monomers that can be polymerised by electromagnetic radiation, preferably dental UV-polymerisable monomers.

The subject matter of the invention is a device comprising, in particular, an assembly with a light source, in particular for producing a homogenised distribution of light intensity, for production of a three-dimensional object by means of illuminating a liquid light-curing plastic material, having a container for accommodation of a bath of the light-curing liquid plastic material, a building platform for positioning the object relative to the surface (z-axis) of the bath, whereby the container has a feeding device for feeding the liquid light-curing plastic material assigned to it, in particular the feeding device is assigned to the container at a level below the surface of the bath, whereby the feeding device comprises an exit opening in the container and a pipeline, whereby the pipeline is connected to a pump, moreover, at least one collecting container is assigned to the container, in particular two collecting containers that are opposite from each other and are situated on the side of the container are assigned to the container, in particular are assigned on the side along the longitudinal or transverse axis of the container. The liquid light-curing plastic material, preferably the protruding plastic material having an arched surface, is transferable into the at least one collecting container, preferably in a planar surface, by means of a stripping device that can be driven along an axis of the container. The drivable stripping device preferably comprises a scraper that has a planar underside. The scraper can comprise a rubber lip.

The device according to the invention is designed appropriately such that it is the first to utilise the surface tension of the light-curing plastic material and/or of a polymerisable composition in order to provide an excess of the curable plastic material above the previously cured layer or above the building platform. Only afterwards, a stripping device, which is fixedly oriented at a defined distance from the upper edge of the container for example at a height difference of 0.1 mm, is used to attain the planar plastic material surface.

It is particularly preferred in this context that the liquid light-curing plastic material present in the device, in particular the plastic material that protrudes vertically beyond the walls of the container and has an arched surface due to the surface tension of the plastic material, is transferable into at least one collecting container by means of a stripping device that can be driven along an axis, in particular a longitudinal or transverse axis, such as a longitudinal centre axis, of the container, whereby, in particular, a surface, preferably a planar surface, is formed as projection surface. According to a further preferred embodiment, the light source, in particular a spatially emitting light source, is guided across a projection surface together with the illuminated field of the projected light source, which is projected by means of an optical system, whereby the light source is simultaneously guided along an axis of the container by means of a stripping device that can be driven along an axis, in particular a longitudinal or transverse axis, of the container. Accordingly, a device according to the invention preferably comprises an entire assembly that comprises a stripping device that can be driven along an axis of the container, and assembly 0, whereby the stripping device is situated in front of the light source and/or of the illuminated field, in particular of the assembly, and whereby the light source is simultaneously guided along an axis of the container by means of a stripping device that can be driven along an axis of the container.

Another subject matter of the invention is a device comprising an assembly (0) that comprises an arrangement, whereby the arrangement comprises a light source, in particular a spatially emitting light source, a spatial light modulator, and an optical system. In this context, it is preferred that a lens system forms the optical system. The light source can be a UV laser or a data projector such as an UV-LED data projector.

According to a further embodiment, a subject matter of the invention is a device having a feeding device that is assigned to the container at a level below the surface of the bath, in particular, the feeding device comprises an exit opening in the container and comprises a pipeline that connects the exit opening and a pump. The exit opening is preferred to be below the bath surface.

Another subject matter of the invention is a device by means of which the liquid light-curing plastic material can be fed again from the collecting container to the bath via the feeding device by means of a suction line, in particular through a filter, by means of a pump, preferably a hose pump or membrane pump. It is particularly important in this context to make sure that there are no bubbles during the feed.

According to a particularly preferred embodiment of the invention, the device comprises an assembly 0#—entire assembly—comprising a stripping device that can be driven along an axis (x, y plane) of the container and a smaller assembly, whereby the stripping device is situated in front of the light source of the assembly 0. The stripping device is attached at a defined distance in front of the light source, in particular 20 to 150 mm, preferably 20 to 80 mm. Preferably, the drivable stripping device and the light source of the assembly 0 form an entire assembly 0# that can be coupled and driven. According to a preferred embodiment, the stripping device comprises a coupling device and is pushed ahead of the light source and/or of the illuminated field of the light source by means of a sword that is assigned to the light source or the assembly 0. The sword can preferably be guided, in the region of the reversal points of the assembly on the container on the front and rear end of the container, through a coupling device in order to again position the stripping device in front of the light source when the entire assembly 0# is driven again across the container along the return path. Due to a sword being assigned to the light source or the assembly 0 and the sword being guided, at the endpoints (reversal points of the entire assembly 0# in the container), through the coupling device of the stripping device, the sword can push the coupling device and thus the stripping device ahead of the light source and/or of the illuminated field upon a change of direction of the assembly. Preferably, the coupling device is a device comprising two elements, in particular trapezoidal elements, preferably symmetrical elements containing at least one trapezoid, that can be pushed against each other by means of springs. The elements are preferably appropriately designed and aligned with respect to each other such that a recess is formed between them in a horizontal plane that can be widened to a gap by the sword by pushing the two spring-supported elements apart. The sword can be pivoted through said gap in the region of the reversal point in order to be able to again guide the coupling device across the surface of the plastic material in front of the sword, when the entire assembly 0# is being returned. An attenuator is positioned at the reversal points and stops the scraper (wiper, slider) and builds up pressure until the sword pushes through the above-mentioned recess of the coupling device and the gap that is being formed. As soon as the sword is arranged on the opposite side of the coupling device, the assembly 0 can again push the scraper across the container in the opposite direction.

The lower edge(s) of the stripping device is/are adjusted to be at a defined distance with respect to the planar upper edges of the side walls of the container, preferably a distance of, e.g., 0.1 mm can be pre-adjusted. Alternatively, the stripping device can be guided across the planar upper edges of the side walls of the container.

The assembly 0—small assembly—comprises an arrangement comprising a spatially emitting light source, a spatial light modulator as well as the optical system, which is preferred to be a lens system. The light source can comprise an UV laser or a data projector. The data projector can, for example, be a data projector with DLP (Digital Light Processor) technology made by Visitech AS. It is preferred to use a micro-mirror reactor in the DLP technology. Preferably, the optical power of the UV light source is in the range of 0.5 to 100 W. Preferred emission wavelengths of the light source are 340 nm to 500 nm.

According to a particularly preferred embodiment of the invention, the stripping device is guided, simultaneously and together with the light source, in front of the illuminated field of the light source along an axis of the container (x, y plane) in order to form the layer of plastic material to be polymerised (x1, y1) as a projection surface onto which the illuminated field is projected and the plastic material is polymerised due to the illumination in the illuminated field. In the scope of the invention, simultaneous shall be understood to mean simultaneous guiding of the stripping device and light source along an axis of the container. According to the invention, step a), the level regulation of the bath and generation of the arched surface, preferably takes place at the reversal point of the illumination process and/or in the procedural step, in which the assembly has its reversal point.

Another subject matter of the invention is a method for producing a three-dimensional object, in particular of at least one part of a dental prosthetic part, as well as prosthetic parts obtainable according to said method, in which the three-dimensional object, such as a dental prosthetic part, is generated layer-by-layer, by one layer (x1, y1) each being produced as a projection surface of a liquid light-curing plastic material and being polymerised in an illuminated field, at least in part, by light of a light source, preferably of a spatially emitting light source, whereby

a) a layer (x, y) of the liquid light-curing plastic material is generated on a building platform and/or mounting or on a polymerised layer by the amount of the plastic material being appropriately adjusted in a bath of the liquid light-curing plastic material such that

i) the plastic material protrudes vertically (z axis) at the upper edge of the side walls of the container due to the surface tension of the plastic material, and flows into the at least one collecting container arranged on the side of the container, and an arched surface of the protruding plastic material is formed, or

ii) the plastic material protrudes vertically (z axis) at the upper edge of the walls of the container due to the surface tension of the plastic material and forms an arched surface, and, optionally, the plastic material flows into the at least one collecting container arranged on the side of the container, followed by

b) the protruding liquid light-curing plastic material of the arched surface being removed by a stripping device that can be driven along an axis, in particular the longitudinal or transverse middle axis (x, y plane), of the container and a layer to be polymerised (x1, y1) being obtained, in particular a planar surface, and, optionally,

c) the layer to be polymerised (x1, y1) generated in b) is polymerised as projection surface of the liquid light-curing plastic material by an illuminated field by light of a light source, in particular of a spatially emitting light source, and, optionally,

d) lowering the building platform by one layer thickness (z1) and, optionally,

e) steps a) to d) are being repeated at least one to multiple times.

The building platform serves for adjustment of the z axis for layer-by-layer construction of the objects.

The method can be implemented as a static method. In a static method, the drivable wiper is driven along an axis of the container. A static light source is used for illumination. However, according to a particularly preferred alternative of the invention, the light source can be driven along an axis of the container and, in addition, can preferably be coupled to the wiper and/or stripping device. According to a particularly preferred embodiment variant, steps b) and c) are implemented simultaneously. The simultaneous implementation of the formation of the planar surface as projection area and the ensuing illumination can be realised according to the invention by a drivable stripping device and the light source forming an entire assembly 0# that can be coupled and driven, i.e. the stripping device and the light source or the assembly 0—small assembly—can be coupled to and uncoupled from each other, in particular mechanically, magnetically and/or electrically, and form the entire assembly 0#.

Another subject matter of the invention is a method, in which the assembly 0#—entire assembly—comprises a drivable stripping device and an assembly 0—small assembly—, whereby the assembly 0 comprises an arrangement comprising a spatially emitting light source, a spatial light modulator, and the optical system, whereby the optical system, in particular, is formed by a lens system.

It is another advantage of the method according to the invention that the liquid light-curing plastic material can be fed again from the collecting container to the bath. According to the invention, it is preferred for the device to be protected from electromagnetic radiation or to be set up in a dark room.

Moreover, it is preferred to implement the method with the steps by performing step a) i) after performing step d), or ii) after performing step c) and preferably d), or iii) after the drivable stripping device, the light source or the entire assembly 0# have been guided across the illuminated field and are situated outside of the illuminated field or iv) after the drivable stripping device, the light source or the entire assembly 0# have become situated at a front or rear end of the container, in particular in the region of the reversal point. Front and rear shall be understood to mean the regions of the side walls of the container, in which the wiper and the light source have their reversal points. According to the invention, it is preferred to have the regulation of the level of the filling level take place, as in step a), at the reversal points of the illumination process.

According to a preferred embodiment variant, the upper edges of the walls of the container and the lower edge of the stripping device can be situated in the plane of the projection surface.

Moreover, it is preferred for the assembly to comprise, for homogenisation of the distribution of light intensity, a spatial light modulator that comprises a multitude of controllable and tiltable micro-mirrors that are arranged in rows and columns, in which the light of a spatially emitting light source is projected by means of an optical system and an illuminated field of the projected light source is guided across a projection surface, with the layer (x1, y1) preferably being the projection surface, whereby, towards the middle of the illuminated field, an increasing number of pixels is not being illuminated such that a homogenisation of the light intensity of all pixels that are illuminated on the projection surface is attained in the time integral.

Also a subject matter of the invention is a method, in which the assemblies 0# or 0 and thus the illuminated field and the stripping device are simultaneously guided periodically across the projection surface, whereby, preferably, the surface of a liquid light-curing plastic material, in particular the layer (x1, y1), is used as projection surface.

According to a further subject matter of the invention, a rapid prototyping method is claimed, in which a liquid light-curing plastic material is illuminated according to a method described above, preferably is illuminated with UV light, whereby the stripping device is guided simultaneous and together with the illuminated field ahead of the illuminated field along an axis (x, y plane) of the container, in particular is guided across the container, in order to form the layer of the plastic material to be polymerised (x1, y1) as projection surface onto which the illuminated field is projected and the plastic material polymerises by illumination in the illuminated field.

Another subject matter of the invention is the use of a device according to the invention for producing at least parts of dental prosthetic restorations.

The method can just as well be modified such as to use, for producing a homogenised distribution of light intensity, a spatial light modulator that comprises a multitude of controllable and tiltable micro-mirrors that are arranged in rows and columns, in which the light of a spatially emitting light source is projected by means of an optical system and an illuminated field of the projected light source is guided across a projection surface with the spatial light modulator, whereby, towards the middle of the illuminated field, an increasing number of pixels is not being illuminated such that a homogenisation of the light intensity of all pixels that are illuminated on the projection surface is attained in the time integral.

In the scope of the present invention, pixels shall be understood to mean a smallest controllable light source from which the image of the data projector is composed.

The DLP® chips of Texas Instruments or Visitech, for example, which are particularly well-suited, can be used as spatial light modulators.

The invention can provide a data projector, preferably a LED data projector, particularly preferably an UV-LED data projector, to be used as spatially emitting light source. Alternatively, a laser system can be used.

Both the data projector and the laser system preferably emit light of a wavelength selected from 180 to 600 nm, preferably from 230 to 500 nm, particularly preferably from 340 to 500 nm. In general, all polychromatic light sources can be used as data projector, whereby monochromatic light sources or essentially monochromatic light sources are particularly preferred though. The use of monochromatic light sources allows the light intensity and/or the radiation intensity to be made more uniform and thus a more homogeneous polymerisation to be attained. LED-UV data projectors with a wavelength of about 385 nm or laser systems with a laser with a wavelength of approximately 285 nm are particularly preferred. Data projectors with a resolution of more than or equal to 1024×800, preferably more than or equal to 1920×1080 pixels, in particular a high-resolution of up to 100,000 or more pixels are preferred. It is particularly preferred to use spatially emitting light sources with coherent rays of light. Spatial coherence is also attained through a very small distance from the light source 1 and/or the assembly 0 to the illuminated field 5.

A small distance from the spatial light source, arrangement and/or the assembly to the illuminated field shall be defined as 3 mm to 500 mm, in particular 3 mm to 250 mm, particularly preferably 3 mm to 150 mm, preferably 3 mm to 50 mm, alternatively the distance can just as well be 1 mm to 50 mm. According to the invention, the spatially emitting light source, the spatial light modulator, and the optical system, in particular a lens system, form an arrangement. Moreover, the spatially emitting light source, the spatial light modulator, and the optical system, in particular a lens system, are provided as an arrangement in an assembly.

In this context, the invention can provide for a mask stored for triggering the data projector, in particular a programmable mask, to define the non-illuminated pixels in that certain light points of the data projector remain switched off at all times. A mask according to the invention corresponds to a motif of the switched-off light points of the light source, whereby the motif shows up in the illuminated field as non-illuminated pixels, in particular as a static motif of non-illuminated pixels.

Using the stored mask, it becomes very easy to reduce the light intensity in certain areas of the illuminated field. Using said mask, a homogenisation of the illuminated field, in particular a homogenisation of the light intensity of the illuminated field, particularly preferably a homogenisation in the time integral of the light intensity of the illuminated field, can be attained.

As an alternative to the use of a stored mask, the invention can just as well provide the non-illuminated pixels to be defined by blackening of the micro-mirrors or through a spatial light modulator with voids in the micro-mirror configuration or through deflection of the light points by the micro-mirrors.

Omitting individual micro-mirrors can reduce the costs of the spatial light modulator and/or the requisite number of connections. If blackening is used, commercially available fully-configured spatial light modulators can be used.

A refinement of the method according to the invention can just as well provide the number of non-illuminated pixels to increase towards the middle according to a function, preferably linearly or according to a parabola, particularly preferably according to a function that takes into account the interferences that are present, preferably according to a function that improves the coherence of the illuminated field, preferably of the motif to be illuminated and/or printed.

As a result, the deviations in the intensity of the illuminated field, which typically occur due to the optical system, can be compensated for particularly well. A function as specified compensates particularly well for the increase in intensity in the middle of the illuminated field.

In this context, the invention can provide the function to be determined, preferably calculated, depending on the inhomogeneity of the illuminated field caused by the optical system, in particular a lens system.

Preferably, the function is determined, preferably calculated, depending on the inhomogeneity of the illuminated field caused by the spatial light source, the arrangement comprising the spatial light source, the spatial light modulator and/or the optical system. Alternatively, the function is calculated depending on the inhomogeneity caused by the assembly comprising the light source.

The function according to which the number of non-illuminated pixels increases towards the middle of the illuminated field is determined as function of a reference 1, which indicates the original light intensity of the light source in the illuminated field on the projection surface (plane), and correlates it to reference 2, which indicates the homogeneous, spatial light intensity (energy density in the plane, averaged over x pixels) of the projection surface, in particular over 12×13 to 1920×1080 pixels. The projection surface can just as well comprise a higher resolution of pixels.

This measure also serves to provide for accurate compensation of the construction-related errors in the intensity distribution and to thus generate an illuminated field that is as homogeneous as possible.

According to a particularly preferred embodiment of the method according to the invention, the invention can just as well provide the intensity distribution of the illuminated field to be measured or calculated at maximal illumination by the light source and the spatial light modulator, and the number of non-illuminated pixels in each row and/or column to be determined therefrom.

This provides a particularly well-suited method that allows even specific intensity deviations of certain light sources, such as types of data projectors or individual data projectors, to be compensated by simple means.

According to a preferred embodiment, the invention can provide the spatially emitting light source, preferably the arrangement comprising the spatially emitting light source and/or the assembly comprising a spatially emitting light source, to be guided across the projection surface in order to guide the illuminated field of the projected light source across the projection surface, whereby the illuminated field can be guided back-and-forth across the projection surface. This can take place in continuous or discontinuous manner. Preferably, the assembly is periodically guided across the projection surface.

As a result, a method that is particularly easy to implement is provided for implementation of the method in rapid prototyping. Said method is less error-prone than other methods, in particular those, in which only the illuminated field is guided across the projection surface.

A refinement of the method according to the invention proposes to periodically guide the illuminated field across the projection surface. Periodic sweeping across the projection surface attains a more uniform intensity along the direction of motion of the illuminated field.

The illuminating single images of the motif are obtained by a superimposition a) of the extracted single images of the motif, i.e. derived from the motif to be printed shown as single motifs in the scrolling process and/or guidance of the arrangement comprising the light source across the projection surface with b) the motif of the switched-off light points or the motif of the mask. The light intensity of the illuminating single images of the motif is homogenised as compared to illumination without spatial light modulator or mask.

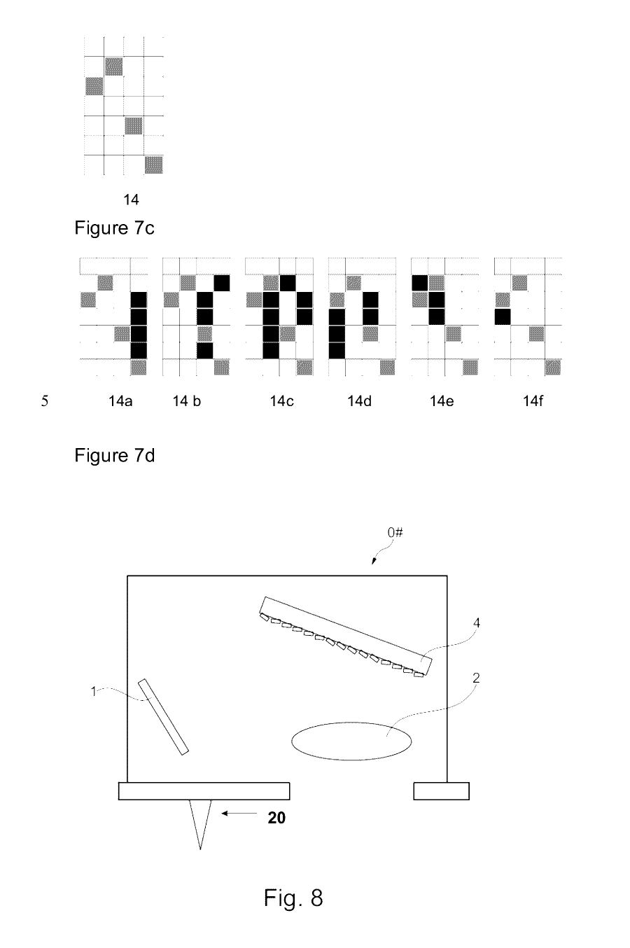

According to a particularly preferred embodiment variant, the method involves generating illuminated single images of the motif in the illuminated field through a superimposition a) of extracted single images of the motif and b) the motif of the switched-off light points. The extracted single images of the motif correspond to the motif to be printed that has been decomposed into single images of the motif for the scrolling process (FIG. 7b).

The motif of the switched-off light points (FIG. 7c) shows the non-illuminated pixels, the static motif of non-illuminated pixels. The illuminating single images of the motif (FIG. 7d) are obtained through a superimposition of the corresponding single images of the motif (extracted single images of the motif, FIG. 7b) and the static motif of the switched-off light points, shown as static motif with non-illuminated pixels.

The motif to be printed is obtained by guiding the illuminated field with the illuminated single images of the motif across the projection surface.

The invention can just as well provide for the surface of a liquid light-curing plastic material to be used as projection surface. In particular, a light-curing dental material is used as light-curing plastic material. According to the invention, the initiator system of the light-curing plastic material and the wavelength of the light source are matched optimally to each other.

A light-curing plastic material shall be understood to be a resin or, preferably, a mixture of light-curing monomers comprising, optionally, photoinitiators or a photoinitiator system. It is particularly preferred to use dental light-curing plastic materials in the method according to the invention. The dental light-curing plastic materials can further comprise filling agents and usually comprise alkyl(meth)acrylates. Using a liquid light-curing plastic material as projection surface, the method is well-suited for producing three-dimensional form bodies (synonym: objects) (as so-called rapid prototyping method). The underlying objects of the invention are also met by a rapid prototyping method, in which a liquid light-curing plastic material is illuminated by means of a method of this type, preferably is illuminated by UV light, whereby the illuminated field is projected onto the surface of the plastic material and the plastic material is cured through the illumination of the illuminated field.

The method according to the invention for homogenising the light intensity of the illuminated field has a particular impact on rapid prototyping methods, since the objects and/or plastic bodies thus made can be built-up homogeneously.

The invention is based on the surprising finding that the use of dead and/or permanently black pixels, i.e. non-luminous pixels, allows a homogenisation of the UV light intensity to be attained without having to adjust grey values with the spatial light source for this purpose. A previously defined mask, which is stored in a data projector, preferably an UV data projector, can be used in this context. The number of pixels defined to be black in the rows and/or columns, i.e. non-luminous pixels, increases towards the middle of the illuminated field in order to compensate for the optical system-related attenuation in intensity of the illuminated field towards the periphery. This is necessary since the middle rows (and/or columns) are illuminated more brightly for constructive reasons (due to the optical system).

The effect of the method according to the invention is as follows. The motion of the data projector and/or of the radiation originating from the data projector causes the entire row of the illuminated field to be triggered during an illumination. As a result, a maximal light intensity (amount of UV light) is generated during the sweep. In an illuminated field consisting of, for example, 1920×1080 pixels, the maximal light intensity would be generated with 1080 pixels. If fewer pixels are triggered, the power and/or the time integral of the light intensity is/are reduced. According to the invention, the uneven illumination of the optical system is compensated by this means.

Exemplary embodiments of the invention shall be illustrated in the following on the basis of schematic figures, though without limiting the scope of the invention. In the figures:

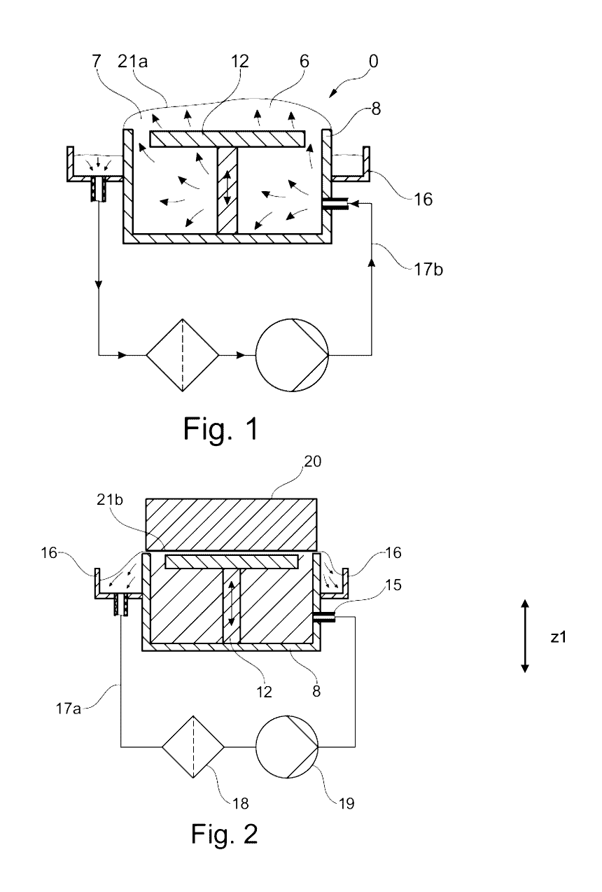

FIG. 1: shows a device according to the invention with the arched surface 21a of the polymerisable plastic material.

FIG. 2: shows a device according to the invention with the planar surface 21b of the polymerisable plastic material.

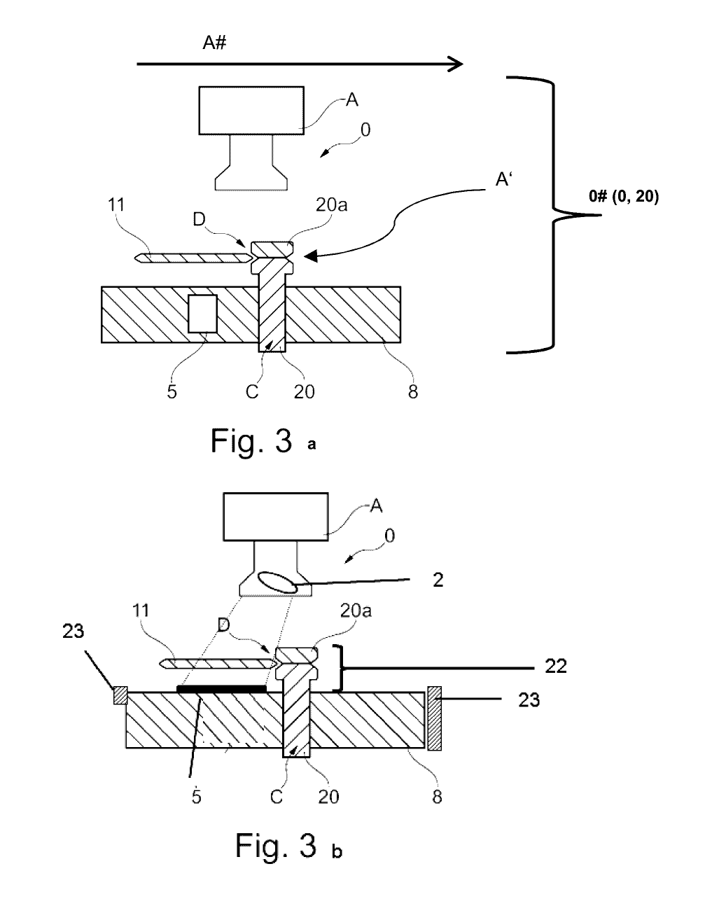

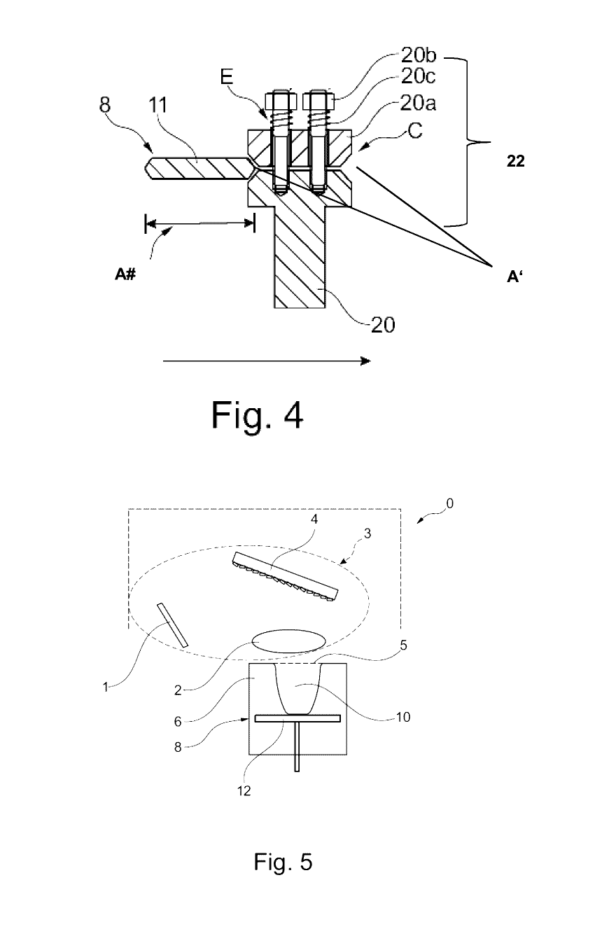

FIGS. 3a, 3b, and 4: show a coupling device and coupling element.

FIG. 5: shows a cross-sectional view of a schematic set-up for implementation of a method according to the invention; and

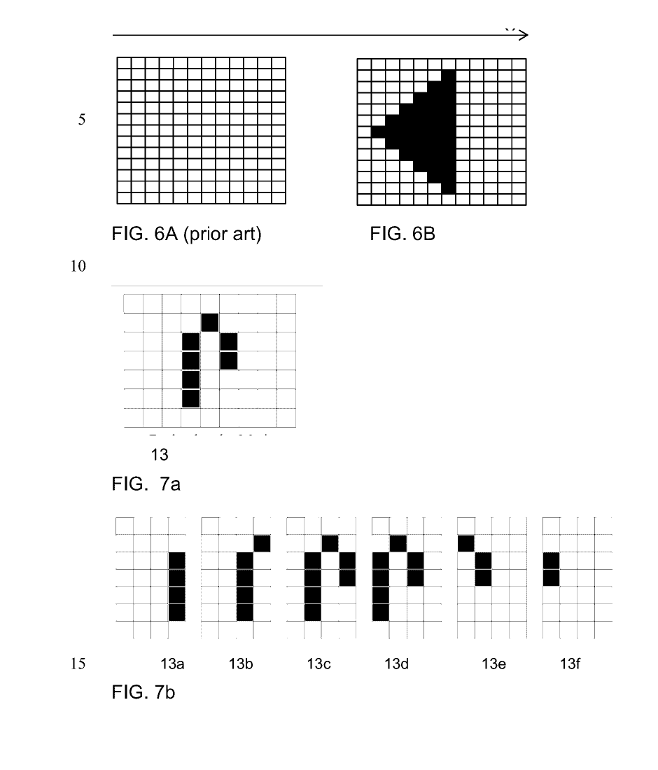

FIG. 6: shows a schematic comparison of a fully illuminated UV data projector chip according to the prior art (FIG. 6A) and a UV data projector chip operated according to the invention (FIG. 6B).

FIG. 7a: shows a motif to be printed (13), whereby the light points are shown as black pixels;

FIG. 7b: shows the images that are projected individually by the light source (1) of the data projector (extracted single images of motif 13a, 13 b, 13c, 13d, 13e, 13f) for generation of the motif to be printed (13) during the motion of the light source across the projection surface (with no mask), whereby the light points are shown as black pixels;

FIG. 7c: shows a motif of the switched-off light points (14) generated by means of a mask or by switched-off light points generated by the spatial light modulator for compensation of illumination differences, whereby the switched-off light points are shown as grey pixels;

FIG. 7d: shows an addition and/or superimposition of the motif of the switched-off light points (14) generated by the spatial light modulator and/or the mask and the extracted single images of the motif (13a to 13f), whereby the mask with the switched-off light points (14) is shown as grey pixels and the light points are shown as black pixels. The motif of the switched-off light points (14, negative motif) shown as grey pixels is shown statically in all single images of the motif as superimposition and/or subtraction, i.e. of the motif of the permanently faded-out or switched-off light points (14) of the single images of the motif (13a to 13f) of the motif to be printed (13) and shown as superimposition in the single images of the motif to be illuminated (14a, 14b, 14c, 14d, 14e, 14f).

FIG. 8: shows the entire assembly (0#) comprising a stripping device (20) that can be coupled to and uncoupled from the assembly (0).

The inventive “Illumination process and procedure of the stereolithography process” involves the regulation of the level of the filling level in the reversal points of the illumination process. During the period of time, in which the illumination unit (assembly 0, 0#) is being decelerated and then accelerated again, the hose pump 19 (FIG. 1, 2) pumps a sufficient amount of resin (polymerisable plastic material, composition comprising monomers) into the container 8. Said amount must be selected appropriately such that a sufficient amount of resin is built up beyond the wall 8a of the container 8. Thus the arched surface 21a (FIG. 1) is formed. Due to the surface tension of the resin and/or plastic material, said elevated amount of material is retained until the scraper (stripping device 20) wipes it off and smoothes the surface. The layer (x1, y1) with the projection surface has been formed (FIG. 2), said layer also corresponds to surface 21b. Accordingly, the illumination unit (assembly 0, 0#) drives along an axis of the container and pushes the scraper across the surface and smoothes the surface 21b by wiping off the excess of material. The surface 21b simultaneously forms the planar projection surface. The material leaking over the wall 8a (FIG. 2) is collected in the collecting container (FIG. 2) and is returned to the pump cycle (FIGS. 1 and 2) through a suction opening with a suction line 17a. This ensures that the level always remains constant during the construction process and/or illumination phase.

The building platform 12 (FIGS. 1 and 2) is lowered by one layer thickness and the process commences again.

The horizontal positions of the container 8 and of the scraper 20 do not change during the construction phase and/or method. Said positions are adjusted once and then remain unchanged. The vertical distance with respect to each other is adjusted and aligned by a defined value (this value is 0.1 mm in the first test). The distance mainly serves to maintain a mechanical and vibration-free separation of the two systems (coating system (assembly, stripping device)=in motion/container system=static). The distance should not be larger than the height that can be attained by the liquid through surface tension. Preferably, the distance is the same or somewhat smaller.

The wiped-off light-curing plastic material is suctioned into the cycle by means of a suction line 17a and a suction pump 19 (FIG. 2) and preferably filtered (Filter 18) and returned to the container 8 (trough). The system is tight in order to prevent the ingress of air into the cycle. Inclusions of air interfere with the polymerisation and/or construction process and lessen the quality of the form body/object.

FIGS. 3a (non-perspective, schematic) and 4 schematically show the coupling device 22 between the assembly 0 or the light source 1 and the stripping device (scraper) 20. According to FIGS. 3a, 3b, and 4, a sword 11 is assigned to the light source 1 or the assembly 0 by means of which these can push the stripping device 20 ahead of them by means of the coupling device 22. Arranged in front of the illuminated field 5 of the light source 1, the stripping device is pushed ahead of the illuminated field 5, preferably horizontally. The coupling device 22 is provided on the top part of the stripping device and comprises at least one element 20a that is connected to the upper end of the stripping device, which can just as well be present as element 20a, by means of an elastic element, such as a spring mechanism 20c and a fixation 20b. An attenuator 23 that decelerates the stripping device 20 can be assigned to the sword 11 in the region of the reversal point of the container. The sword of the assembly 0 or of the light source 1 is then pushed into the recess A between the two elements 20a. Once a certain pressure is reached, the sword pushes the two elements 20a apart and glides through between these elements. The elements 20a are pressed against each other again by the elastic elements 20c. When the direction is changed subsequently (reversal point), the sword 11 again pushes the stripping device ahead of itself across the container. When, in the method according to the invention, the illumination unit 0, 0# with UV data projector 1 (UV-LED data projector; in assembly 0, 0#) is driven across the surface 21a, 21b symmetrically to the container 8 and at a defined distance and when the illuminated field 5 is guided, preferably horizontally, across the projection surface thus formed, the scraper 20 (stripping device) for smoothing the surface is automatically guided along ahead of the light source 1 or ahead of the illuminated field 5 (drag method). FIG. 3b shows the illuminated field 5 on top of the plastic material in the container 8. The illuminated field 5 can be projected onto the protection surface and/or the surface 21b by means of a lens 2.

FIG. 5 shows a schematic cross-sectional view of a set-up for implementing a method according to the invention. An UV-LED data projector 1 emitting ultraviolet light (UV light) is made to emit at a spatial light modulator 4. The UV-LED data projector 1 has a resolution of 1920×1080 pixels that emit as a rectangular area on the surface of a chip of the UV-LED data projector 1. The spatial light modulator 4 comprises a multitude of controllable micro-mirrors and by means of which the light from the UV-LED data projector 1 is reflected and projected onto the surface of a liquid light-curing plastic material 6 by means of a lens system 2. The micro-mirrors are shown in FIG. 1 as small rectangles, differing in orientation, on a surface of the spatial light modulator 4. The liquid plastic material 6 is arranged in a container 8 that is open in upward direction toward the spatial light modulator 4 and/or the lens system 2.

Shown schematically as only a simple lens in FIG. 5, the lens system 2 projects the area of the pixels of the UV-LED data projector 1 onto the surface of the light-curing plastic material 6. Using a suitable motor (not shown), the UV-LED data projector 1 is moved across the container 8 and thus the illuminated field is swept across the surface of the light-curing plastic material 6 such that each row of the chip of the UV-LED data projector 1 travels or can travel fully across any point to be illuminated.

The illuminated field thus generated on the surface of the light-curing plastic material 6 cures the liquid components such that a solid plastic body 10 arises. The solid plastic body 10 is supported as in a bearing on a mounting 12, which is slowly being lowered such that the upper surface of the plastic body 10 is wetted by the liquid light-curing plastic material 6 and a new solid layer can be generated on the plastic body 10 by means of the illuminated field. For details regarding the implementation, reference shall be made to EP 1 880 830 A1 or EP 1 894 705 A2.

A homogenisation of the field of light and therefore of the plastic body 10 thus generated is attained in that the pixels arranged in the middle of the chip of the UV-LED data projector 1 are not used, i.e. in that they remain black. For clarity, a use according to the invention and/or a triggering according to the invention of a chip of this type is shown in FIG. 6B and shall be explained in the following.

FIG. 6 shows a schematic comparison of a fully illuminated UV data projector chip according to the prior art (FIG. 2A) as compared to a UV data projector chip operated according to the invention (FIG. 6B). The UV-LED chip shown for exemplary purposes has only 12×13 pixels to allow the underlying principle of the present invention to be illustrated easily. In a real embodiment, UV-LED data projectors of significantly higher resolution are used, for example 1920×1080 pixels.

Each of the UV-LED chips has 12 columns and 13 rows. In the fully illuminated UV-LED chip according to the prior art (FIG. 6A), the inner areas of the illuminated field are illuminated with a higher UV intensity than the outer areas. As a result, the highest intensity is produced in the middle column and the intensity decreases towards the outside. Due to scattering effects and other phenomena related to the optical system, the individual pixels of the UV-LED data projector cannot be projected at any desired image sharpness. Accordingly, each pixel also illuminates the areas of the illuminated field that should be illuminated by its neighbouring pixels. As a result, areas of the illuminated field illuminated by the inner pixels receive a higher intensity than the areas of the illuminated field illuminated by the outer pixels.

This is compensated with respect to the columns (from top to bottom in FIG. 6) in that the UV-LED data projector is driven across the illuminated field along a direction of motion X. The direction of motion X of the UV-LED data projector and/or of the illuminated field is indicated by the arrow in FIGS. 6A and 6B. Accordingly, the image emitted by the UV-LED chips is being moved across the illuminated field in the direction of the rows (from left to right in FIG. 6, i.e. along the arrow X). A DLP® chip made by Texas Instruments can be used for projection.

The black pixels shown in FIG. 6B, which remain switched-off or are not reflected onto the surface of the liquid light-curing plastic material by the spatial light modulator, progressively reduce the light intensity towards the middle in the different columns of the UV-LED data projector operated according to the invention. As a result, the middle areas of the illuminated field swept along the direction of motion X receive the same intensity of ultraviolet radiation as the outer areas (rows).

The simplest embodiment of a method according to the invention can be implemented by storing a mask for the data projector that defines which of the pixels are not switched-on and/or used and thus remain black. Alternatively, a spatial light modulator that comprises fewer or blackened mirrors in the middle can be used just as well.

In FIG. 6B, only the outermost two rows are irradiated by all twelve pixels, whereas one pixel less lights up and/or is projected for each row closer to the middle row. In the middle row, only six pixels are active and/or only six pixels are projected. Sweeping across the illuminated area along the direction of motion X, a mean illumination intensity is generated at the illuminated points of the illuminated field and the mean illumination intensity is directly proportional to the number of pixels of the UV-LED data projector that are used and/or projected. Suitable data projectors can have a resolution of up to 100,000 or up to 1.5 million pixels. Just as well, data projectors projecting in XGA and super-XGA (SXGA) resolution of 1.280×1.024 pixels can be used.

In order to attain a uniformly homogenised distribution of light intensity on the surface of the light-curing plastic material and/or of the projection surface, in particular on a planar projection surface, the illumination field is guided across a building platform at a constant velocity. Presently, the building platform is 1,920×20,000 pixels in size (pixel size presently is 50×50 μm). During the motion, image details are constantly reproduced via the illuminated field.

Once it is defined, the mask stored in the UV data projector generates dead (permanently black) pixels in the individual rows. In this case, the number of pixels in the rows defined to be black increases towards the middle, since the rows in the middle are illuminated more brightly for constructive reasons (due to the optical system).

The effect is as follows: Due to the motion of the UV data projector, the entire row of the illuminated field is triggered during an illumination. As a result, a maximal amount of UV light of 1080 pixels is generated during the sweep. If fewer pixels are triggered, the power is reduced and the uneven illumination of the optical system can be balanced.

FIG. 7a shows a motif to be printed 13, in which the light points are shown as black pixels. FIG. 7b shows the sequence of images that are projected individually by the light source (extracted single images of the motif 13a, 13 b, 13c, 13d, 13e, 13f) for generation of the motif to be printed 13 during the motion of the light source or of the arrangement across the projection surface (without motif of the switched-off light points and/or with no mask). The light points are shown as black pixels. FIG. 7c shows the motif of the switched-off light points 14. The motif of the switched-off light points is generated by the spatial light modulator and/or the mask. The switched-off light points are shown as grey pixels. In this manner, light points can be switched-off or deflected by the spatial light modulator in order to balance out differences in illumination.

FIG. 7d shows the superimposition of the motif of the switched-off light points 14, in particular of the static motif, generated by the spatial light modulator and/or the mask and the extracted single images of the motif 13a to 13f. The motif of the switched-off light points 14 or the mask are shown as grey pixels. The illuminated pixels in the illuminated field are shown as black pixels and form the single images of the motif to be illuminated (14a, 14b, 14c, 14d, 14e, 14f).

FIG. 8 shows the entire assembly (0#) comprising a stripping device 20 that can be coupled to and uncoupled from the assembly 0. For polymerisation of the plastic material 6, the light source 1 or at least the illuminated field 5 of the light source 1 is guided ahead of the entire assembly 0# or the assembly 0 behind the stripping device 20. The stripping device 20 can be coupled, in particular by means of the coupling device 22, to the light source 1 or to the illuminated field 5 of the light source 1 and is guided ahead of the light source 1 or the illuminated field 5.

The features of the invention disclosed in the preceding description and in the claims, figures, and exemplary embodiments, can be essential for the implementation of the various embodiments of the invention both alone and in any combination.

### LIST OF REFERENCE NUMBERS

0 Assembly comprising light source (1) and/or (A), such as UV-LED data projector (1) or laser system, optical system, in particular lens system (2), spatial light modulator (4),
0# Entire assembly comprising:
   Stripping device (20) and assembly (0) comprising light source (1), such as UV-LED data projector (1) or laser system, optical system, in particular lens system (2), spatial light modulator (4), whereby the stripping device can be coupled to or uncoupled from the assembly (0)
1 UV-LED data projector
2 Lens system
3 Arrangement of the spatial light source (1) of the spatial light modulator (4) and/or of the lens system/optical system (2)
4 Spatial light modulator
5 Illuminated field
6 Light-curing liquid plastic material, in particular mixture comprising monomers, composition comprising dental monomers
7 Bath
8 Container
10 Cured light-curing plastic material/plastic body
11 Sword, preferably having a geometry that is adapted to the coupling device and/or recess A
12 mounting, building platform
13 Motif to be printed
13a to 13f individually projected images for generating the motif to be printed
14 Motif of the switched-off light points/motif of non-illuminated pixels
14a to 14f single images of the motif to be illuminated, with a homogenised distribution of light intensity. Images projected individually (14a, 14b, 14c, 14d, 14e, 14f) for generating the motif to be printed 13, shown as individually projected images (13a, 13b, 13c, 13d, 13e, 13f) for generating the motif to be printed during scrolling with a static superimposition of the motif of the switched-off light points (14)
15 Feeding device
16 Collecting container
17 Pipeline, 17a suction line, 17b feeding line
18 Filter
19 Pump, in particular hose pump
20 Stripping device, scraper (C)
20a Element, in particular plate
20b Fixation, in particular screw (E)
20c Elastic element, in particular spring mechanism
21a Surface of bath during overflow of plastic material into collecting container,
21b Surface (planar surface) of bath corresponding to illumination or after adjustment of the surface by stripping device, scraper. The surface 21b corresponds, at least in part, to the projection surface and/or is the surface of the layer to be polymerised (x1, y1).
22 Coupling device, A′ recess, in particular comprising 20a, 20b, 20c and 20 or upper part on a scraper 20
23 Attenuator
A′ recess; A# direction of motion; D drag method, E compression springs retained by means of stud bolts, z1: layer thickness; x,y; x1,y1: layer as plane

1. Device comprising an assembly with a light source, for production of a three-dimensional object by means of illuminating a liquid light-curing plastic material, having a container for accommodation of a bath of the light-curing liquid plastic material, having a building platform for positioning the object relative to a surface of the bath, wherein the container has assigned to it a feeding device for feeding the liquid light-curing plastic material, moreover, at least one collecting container is assigned to the container into which the liquid light-curing plastic material is transferable by means of a stripping device that is drivable along an axis of the container.

2. Device according to claim 1, wherein the assembly serves for producing a homogenised distribution of light intensity and comprises an arrangement that comprises a spatially emitting light source, a spatial light modulator, and an optical system, in optionally with the optical system being a lens system.

3. Device according to claim 1, wherein the feeding device at a level below the surface of the bath is assigned to the container.

4. Device according to claim 1, wherein the liquid light-curing plastic material, optionally protruding plastic material of the arched surface is transferable into the at least one collecting container by means of a stripping device that is drivable along an axis of the container, whereby, optionally, a surface is formed as projection surface.

5. Device according to claim 1, wherein the liquid light-curing plastic material is fed again from the collecting container via the feeding device to the bath by means of a suction line, optionally through a filter, by means of a pump.

6. Device according to claim 1, wherein an entire assembly comprises a stripping device that is drivable along an axis of the container, and the assembly, whereby the stripping device is situated in front of the light source and/or of the illuminated field, optionally of the assembly.

7. Method for producing a three-dimensional object, in which the three-dimensional object is generated layer-by-layer, by one layer each being produced as a projection surface of a liquid light-curing plastic material and being polymerised in an illuminated field, at least in part, by light of a light source, said method comprising:
a) generating a layer of the liquid light-curing plastic material on a building platform or on a polymerised layer by the amount of the plastic material being appropriately adjusted in a bath of the liquid light-curing plastic material such that the plastic material protrudes vertically at the upper edge of the walls of the container due to the surface tension of the plastic material, and an arched surface of the protruding plastic material is formed, and, optionally, the plastic material flows into the at least one collecting container arranged on the side of the container, followed by
b) removing the protruding liquid light-curing plastic material of the arched surface by a stripping device that is drivable along an axis of the container and a layer to be polymerised being obtained as projection surface, and, optionally,
c) polymerizing the layer to be polymerised generated in b) as projection surface of the liquid light-curing plastic material by an illuminated field by light of a light source, and, optionally,
d) lowering the building platform by one layer thickness and, optionally,
e) repeating steps a) to d) at least one to multiple times.

8. Method according to claim 7, wherein steps b) and c) take place simultaneously.

9. Method according to claim 7, wherein the drivable stripping device and the light source form a drivable entire assembly that can be coupled and uncoupled.

10. Method according to claim 7, wherein the entire assembly comprises a drivable stripping device and an assembly, whereby the assembly comprises an arrangement comprising a spatially emitting light source, a spatial light modulator, and the optical system, optionally with the optical system (2) being a lens system.

11. Method according to claim 7, wherein the liquid light-curing plastic material is fed again from the collecting container to the bath.

12. Method according to claim 7, wherein step a) is performed
i) after performing step d), or
ii) after performing step c) and, optionally, d), or
iii) after the drivable stripping device, the light source or the entire assembly have been guided across the illuminated field and are situated outside of the illuminated field, or
iv) after the drivable stripping device, the light source or the entire assembly have become situated at a front or rear end of the container, optionally in the region of the reversal point.

13. Method according to claim 7, wherein the entire assembly or the assembly or homogenising the distribution of light intensity comprises a spatial light modulator that comprises a multitude of controllable and tiltable micro-mirrors that are arranged in rows and columns, in which the light of a spatially emitting light source is projected by means of an optical system and an illuminated field of the projected light source is guided across a projection surface, whereby, towards the middle of the illuminated field, an increasing number of pixels is not being illuminated such that a homogenisation of the light intensity of all pixels that are illuminated on the projection surface is attained in the time integral.

14. Method according to claim 7, wherein the entire assembly or the assembly and thus the illuminated field and the stripping device are simultaneously periodically guided across the projection surface, whereby, optionally, the surface of a liquid light-curing plastic material is used as projection surface.

15. Rapid prototyping method, comprising illuminating a liquid light-curing plastic material by means of a method according to claim 7, optionally with UV light, whereby the stripping device is guided simultaneously and together with the illuminated field ahead of the illuminated field along an axis of the container in order to form the layer to be polymerised of the plastic material as projection surface onto which the illuminated field is projected and on which the plastic material polymerises due to the illumination in the illuminated field.

16. A method for the production of at least parts of a dental prosthetic restoration, comprising using a device according to claim 1.
